(19) United States
(12) Patent Application Publication
(10) Pub. No.: US 2021/0141097 A1
(43) Pub. Date: May 13, 2021

(54) GUIDED MOBILE PLATFORM

(71) Applicant: David E. WACHOB, New Hope, PA (US)

(72) Inventor: David E. WACHOB, New Hope, PA (US)

(21) Appl. No.: 16/678,213

(22) Filed: Nov. 8, 2019

(51) Int. Cl. G01S 19/41; G08B 21/18; H04N 7/18; G06K 9/00; G06K 7/14; G06K 7/10

(52) U.S. Cl. CPC G01S 19/41; G08B 21/18; H04N 7/183; G01V 3/16; G06K 7/1417; G06K 7/10722; G06K 9/0063

(57) ABSTRACT

In one embodiment, an apparatus includes a transporter configured to transport the apparatus based on received instructions, a detector configured to detect a predetermined condition, and a receiver configured to receive data from GPS receivers, which include one or more differential GPS receivers. A memory is configured to store, for each of different times, detection data from the detector indicative of whether the predetermined condition was detected, and location data from the receiver related to the data received from the GPS receivers.

### BACKGROUND

Current approaches to “finding things” with a variety of detectors over geographic areas can be very labor and time intensive, even with sophisticated detectors and sensors, especially over an appreciable search area. They also can be prone to human error, as a result of the mundane and laborious search process, oftentimes done by hand.

### BRIEF SUMMARY

The invention greatly expedites and enhances the search process, with improved accuracy and documentation of the search results, over a wide variety of detectable events and geographic environments. The invention integrates a variety of possible detectors (metal, image, Infra-Red, X-Ray, radar, biological, chemical, radiation, gases, RFID, RF, terrain, position, location, speed, acceleration, environmental, etc.) into a variety of possible guided mobile platforms, including portable drones/dronebots, hovercrafts, helicopters, airplanes, or other “roaming devices”. In doing so, it provides for a more efficient and methodical search of an area for a wide variety of substances and/or emissions, including metals and/or metallic objects, missing, dangerous, or suspicious objects, or other objects of interest.

In one embodiment, an apparatus includes a transporter configured to transport the apparatus based on received instructions; a detector configured to detect a predetermined condition; a receiver configured to receive data from GPS receivers, which include one or more differential GPS receivers; and a memory configured to store, for each of different times, detection data from the detector indicative of whether the predetermined condition was detected; and location data from the receiver related to the data received from the GPS receivers.

In another embodiment, a system includes a mobile apparatus comprising a transporter configured to transport the apparatus based on received instructions; a detector configured to detect a predetermined condition; a receiver configured to receive data from GPS receivers, which include one or more differential GPS receivers; and a memory configured to store, for each of different times, detection data from the detector indicative of whether the predetermined condition was detected; and location data from the receiver related to the data received from the GPS receivers; and a processor configured to determine, for each of the different times whether the predetermined condition was detected based on the detection data; and a location of the apparatus based on the location data.

In yet another embodiment, a method includes transporting an apparatus based on received digital instructions, the apparatus comprising a detector configured to detect a predetermined condition; a receiver configured to receive data from GPS receivers, which include one or more differential GPS receivers; and a memory; storing in the memory, for each of different times, detection data from the detector indicative of whether the predetermined condition was detected; and location data from the receiver related to the data received from the GPS receivers; and determining, by a processor, for each of the different times whether the predetermined condition was detected based on the detection data; and a location of the apparatus based on the location data.

### BRIEF DESCRIPTIONS OF THE DRAWINGS

The present disclosure will become more fully understood from the detailed description and the accompanying drawings, wherein:

FIG. 1 is a detailed drawing of the Guided Mobile Platform with a metal detector according to one embodiment.

FIG. 2 is a high level diagram of the system using the Guided Mobile Platform according to one embodiment.

FIG. 3 is a detailed diagram of a Guided Mobile Platform using Other Detectors according to one embodiment.

FIG. 4 is a high level diagram of the system with further enhancement to the Guided Mobile Platform according to one embodiment.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present inventions. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

In the following description, where circuits are shown and described, one of skill in the art will recognize that, for the sake of clarity, not all peripheral circuits or components are shown in the figures or described in the description. Further, the terms “couple” and “operably couple” can refer to a direct or indirect coupling of two components of a circuit.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

The invention leverages recent advances in guided mobile platforms (GMPs) including, but not limited to, drone technology, in terms of their performance, accuracy, flight time and cost effectiveness, especially for the applications described above and herein. In its simplest embodiment, an individual guided mobile platform (such as a drone) is combined with an individual detector (such as a metal detector) to provide a more accurate and efficient metal detection system and method. Included in the guided mobile platform is inherent location determining technology, including, but not limited to, GPS receiver(s) as well as related communication systems. This methodical and efficient metal detection system provides the means and method to scan, detect, record and communicate the location of metal object(s) detected, over a wide search area, with little if any human intervention, in much less time than the current process of metal detection.

FIG. 1 details the block diagram of such a guided mobile platform 100, with the major functional components highlighted. The Processor 101 integrates and controls the various sub-systems as indicated. Navigation is provided by one or more rotor systems, including one or more sets of indicated external rotating blades 103, as well as the rotor control motors (labelled Rotors 102), under command and control from the Processor 101.

Position information is received by one or more GPS receivers 104 (or alternative means), in communications with one or more GPS satellites, via the antennas 105 (and/or potentially supplemented by information supplied by the additional Communications System(s) 106 as indicated in FIG. 1). The position information is forwarded to the Processor 101 where it may be reconciled with additional supplemental information, such as fixed mobile GPS (differential) position info, terrain maps, camera sightings, etc., within the flightpath of the GMP 100, to calculate the GMP's 100 most exact position. The position is then recorded within the Memory 107, as indicated in FIG. 1. This process of calculating and then recording the GMP's 100 current position in Memory 107 is continuously repeated and updated.

Similarly, the Metal Detector 108 included in FIG. 1 is detecting the presence of metal (either a discrete object, pipe or wire, etc.) within the flight path of the GMP 100, through a variety of means, including (but not limited to) an induced current and/or field by the movement within coiled wire(s) (not shown) as part of the Metal Detector 108 circuitry in FIG. 1, as the GMP 100 moves over a metallic object. This current and/or field is then detected and characterized by the Processor 101, in terms of the potential type, composition, size or shape of the metal detected. At the same time, the GMP's 100 position that has been calculated is recorded within Memory 107 with the specific details of the metal's characterization and location, and a record locator preserved for further retrieval and/or processing by the system on board or remote from the GMP 100, to map and/or locate the metallic object later.

Simultaneously, a picture of the detected object and/or site location might also be recorded by any or all of the Cameras 109 indicated in FIG. 1, and stored along with (or separate from) the above record locator, to provide additional details about the object located. If pictures of the detected object located are taken by multiple Cameras 109 on the GMP 100, then a stereoscopic or 3-D image of the detected object can be created, either by the GMP's 100 on-board Processor 101, or by post processing of the separate pictures by a supplemental (and possibly separate) processor, either concurrently or at a later time, communicated via the Communications System(s) 106 in FIG. 1.

As related to the above pictures, within the Memory 107 (or separate from) the GMP 100 could be stored a library of “known objects” which might be detected and recorded by the GMP 100. Upon detection of a potential object by the GMP 100 (or at a later time), the detected image could be compared against the pictures stored in the library of known potential objects for similarity (within a prescribed probability of likeness), to further determine the identity of the detected object. One such (although not the only) example of this would be in the search of coins, to have stored in Memory 107 (or elsewhere) a library of all known coins likely to be found within the designated search area. Upon a match of the detected object with a known coin (or object), the coin (or object) type that matched and associated GPS coordinates could also be recorded, as part of the record locator described above. If something is located and it does not match any of the images stored in Memory 107 (or the image of the located device is buried under ground and not visible), then a record locator can still be recorded within (or external too) the GMP's 100 Memory 107 for further investigation and/or location. Other possible examples of stored objects for comparison could be munitions/land mines, potential bombs or parts of missing aircrafts or ships.

Optional information can also be recorded upon detection of a potential metallic object, such as the GMP's 100 speed and acceleration, to further improve the location accuracy of the detected object. This information, in addition to the combined (GMP 100 and Metal Detector 108) “processing time”, would allow the system to “work backwards” to determine a more precise location of the detected object, based upon the additional distance and direction travelled during the above processing time.

FIG. 2 details the GMP 100 interfacing with the GPS (Global Positioning) Satellite(s) 110, optional Differential GPS Receiver(s) 111, and one or more Controller(s) 112. The GMP 100 receives global positioning information from one or more GPS Satellites 110, already present above the earth. The more GPS Satellites 110 that the GMP 100 is able to receive, the more accurately that the GMP's 100 position can be determined, as indicated by GPS Satellites 110 1 through N, in FIG. 2.

Location information from the GPS Satellite(s) 110 can be optionally supplemented by one or more terrestrial based, fixed location Differential GPS Receivers 111 as indicated in FIG. 2, in communications with the GMP 100 via the GMP 100 Communication System(s) 106, as indicated in FIG. 1. These Differential GPS Receiver(s) 111 also receive GPS position information from the GPS Satellites 110. The Differential GPS receiver(s) 111 serve as calibrated markers for the GMP 100 at precisely known and fixed locations relative to the GMP 100, to further improve the accuracy of determining the position of the GMP 100 at any given time, typically resulting in roughly a 1000 times improvement in the position accuracy of the GMP 100, by cancelling out inaccuracies of the common GPS information received simultaneously by both the GMP 100 and the Differential GPS Receiver(s) 111.

Also indicated in FIG. 2 are one or more Controller(s) 112, to provide remote navigation of the GMP 100 (possibly user directed), if not already provided by the Memory 107 and Processor 101 within the GMP 100 of FIG. 1, for supplemental control of the GMP 100. The Controller(s) 112 could be, for example, a standalone portable controller, an application resident on smart phone, an external fixed controller or server, or any combination thereof. This control process can be performed manually and/or automatically. The Controller(s) 112 are in communications with the GMP 100 as indicated in FIG. 2 (via dotted lines), via the Communication System(s) 106 of FIG. 1, to provide control and navigation of the GMP 100. In addition, any or all of the Controller(s) 112 in FIG. 2 can include memory and processing capabilities to process, present and store the received data, including (but not limited to) raw or processed location and/or GPS data from the GMP 100, including for example, navigation (speed, acceleration, direction) data of the GMP 100, visual data from the GMP 100, sensor data from the GMP 100 (such as the Metal Detector 108, for example), atmospheric condition data (either from the GMP 100, or elsewhere), GMP 100 operating conditions (Battery 113 life, error messages, potential loss of communications, etc.), or any other such data relevant to operating the GMP 100. The Controller(s) 112 might also have stored in memory terrain maps of the search area, to supplement control and guidance of the GMP 100, if these terrain maps are not already downloaded to and/or stored within the Memory 107 of the GMP 100.

The Controller(s) 112 might also optionally include a visual display (LCD or otherwise), to provide the user visual indication of where the GMP 100 is currently located, including projected flight path, as well as other relevant info, including the location of any detected objects, flight conditions, elevation, Battery 113 life of the GMP 100, etc. Additionally, the visual display on the Controller(s) 112, might also provide for visual display information received from any and/or all of the Cameras 109 on board the GMP 100, including general flight display information, terrain, as well as a visual display of potential detected objects.

The Cameras 109 indicated in FIG. 1 can also be used to avoid potential collisions with land or air based objects, present within the flightpath of the GMP 100. This can be done manually by visual observations from the user of the Controller(s) 112 described above, and/or “automatically” by a program (either on-board the GMP 100 or at one or more Controller(s) 112 remote from the GMP 100) and in communications with the GMP 100, which is analyzing the Camera 109 video in conjunction with the GMP's 100 position, flight path info, and any potential terrain information available or other GMPs 100 for possible collisions. The Camera(s) 109 can capture vertical and/or horizontal and/or altitude visual information, as indicated in FIG. 1.

The invention detailed above can be expanded beyond metal detection, with the use of Other Detectors 114, highlighted (within dotted lines) in FIG. 3. These could include a wide variety of additional detectors, such as chemical, biological, radiation, electro-magnetic, “RFID”, Infrared, RF, radar, or even different types of metal detectors (ferrous versus non-ferrous, for example) to name but a few. The detected information from these Other Detectors 114 is likewise interfaced and received by the GMP's 100 Processor 101, and processed and/or communicated and/or stored in all manners similarly to the Metal Detector 108 in FIG. 1, but using different detection criteria relevant to the specific “Other Detector” 114 data.

The above design between the Other Detectors 114 and the GMP 100 can provide for a “common interface”, such that the same GMP 100 can be interfaced with a wide variety of Other Detectors 114, such that the Other Detectors 114 can be easily interchanged with alternate Other Detectors 114 and the GMP 100. Common data interfaces, protocols, voltages and current capacities, weight restrictions, mechanical interfaces, etc. between the Other Detector(s) 114 and the GMP 100 can be “standardized”, allowing for easy and convenient “swapping” of the Other Detectors 114, even in the field, including interfaces for multiple Other Detectors 114 simultaneously.

Data from the Other Detector(s) 114 can be used individually or in conjunction with Other Detector(s) 114, including also the originally described Metal Detector 108, to form a more accurate probability of object detection. One such example of this would be the use of both radiation and chemical detectors, to determine a radioactive and toxic substance, for example. Having positive identifications simultaneously from both these Other Detectors 114 would increase the probability of finding such a radioactive and toxic substance, versus only having a positive identification from one such Other Detector 114. Another such example of using multiple Other Detectors 114 could be the use of both radar and metal Other Detectors 114 to locate metal objects buried beneath the surface.

If one or more of the Other Detector(s) 114 is Infrared and/or radar, than this detected information could also be used to navigate the GMP 100, by supplementing the GMP's 100 GPS (or other) navigation information, with information about the GMP's 100 elevation above the surface or foreign objects within the flight path, as determined by the Infrared and/or radar information.

If one or more of the Other Detectors 114 is an RF detector, then this RF information can be used to receive one or more specific frequencies being transmitted (directly or supplementally) by the object to be located. One (and only one) such application of this could be to locate a black box recorder from a downed aircraft or other vehicle, or to locate a cell phone from a lost or missing person.

As a further enhancement to the optional differential GPS receivers 111 described above, FIG. 4 details visually displaying QR codes 115 (or other identifying marks) on top of the differential GPS receivers 116, such that the GMP 100 can easily locate them, by flying over them, visually identifying the unique QR code 115 associated with that particular differential GPS receiver 116 (via the GMP on-board Cameras 109, Processor 101 and Memory 107 indicated in FIG. 1), and recording the associated GPS position of the GMP 100 and the differential GPS receiver 116 at the time the QR code 115 of the differential GPS 116 is detected. This allows the GMP 100 or one of its Controller(s) 112 in FIG. 2 (or both/all) to reconcile the GMP's 100 GPS position versus the more accurate GPS position of the fixed differential GPS receiver 116. This process can be repeated by the GMP 100 if there are more than one differential GPS receivers 116 with associated unique QR codes 115 at other fixed positions within the flight plan of the GMP 100.

The above process might be further enhanced if each of the differential GPS receivers 116 are tethered to each other via Tethers 117, as also indicated in FIG. 4. These Tethers 117 could be of fixed and known lengths, which could be used to even more precisely determine the exact separation between each differential GPS receivers 116, which could provide for a more exact reconciliation of the GMP's 100 position. One such way to do this would be by comparing the known precise fixed distance(s) between the differential GPS receiver(s) 116 with the Tethers 117, with the calculated difference(s) between the GPS positions received by the differential GPS receiver(s) 116 from the GPS satellites. It should be noted that the use of tethered differential GPS receivers 116 described above can be done with or without the use of the QR codes 115.

Also indicated in FIG. 1 is an external interface to a Charger 118, for charging the GMP 100 for further flights. The GMP 100 could also be charged with an on-board solar cell or panel (not shown), for supplemental charging (in flight or otherwise).

It can be appreciated that any or all of the above techniques detailed above could be applied to any or all of the other types of GMP's 100 described initially, and are not limited to just drones and/or drone.

While the inventions have been described with respect to specific examples including presently preferred modes of carrying out the inventions, those skilled in the art will appreciate that there are numerous variations and permutations of the above described systems and techniques. It is to be understood that other embodiments may be utilized and structural and functional modifications may be made without departing from the scope of the present inventions. Thus, the spirit and scope of the inventions should be construed broadly as set forth in the appended claims.

What is claimed is:

1. An apparatus comprising:
a transporter configured to transport the apparatus based on received instructions;
a detector configured to detect a predetermined condition;
a receiver configured to receive data from GPS receivers, which include one or more differential GPS receivers; and
a memory configured to store, for each of different times:
detection data from the detector indicative of whether the predetermined condition was detected; and
location data from the receiver related to the data received from the GPS receivers.

2. The apparatus of claim 1 further comprising a processor configured to determine, for each of the different times:
whether the predetermined condition was detected based on the detection data; and
a location of the apparatus based on the location data.

3. The apparatus of claim 1 wherein:
the apparatus further comprises a camera;
the data received from the one or more differential GPS receivers comprises data that the camera reads from a QR code on or near each differential GPS receiver, the QR code identifying the differential GPS receiver and its location.

4. The apparatus of claim 1 wherein the one or more differential GPS receivers are at a predetermined distance from one another.

5. The apparatus of claim 1 wherein the processor determines the current location based on a speed and a direction of the apparatus.

6. The apparatus of claim 1 further comprising a transmitter for transmitting the detection data and the location data for the different times.

7. The apparatus of claim 1 wherein the instructions received by the transporter correspond with a predetermined transportation path, or comprise manual, real-time movement instructions from a user.

8. The apparatus of claim 1 further comprising a camera and a processor, the camera configured to transmit image data for an image to the processor, the processor configured to use image processing to determine whether the image corresponds with an object of interest.

9. The apparatus of claim 1 wherein the predetermined condition is a presence of metal.

10. The apparatus of claim 1 wherein the detector detects at least one of a metal, image, infrared, X-ray, radar, biological, chemical, radiation, gas, RFID, RF, terrain, position, location, speed, acceleration, or environmental detector.

11. The apparatus of claim 1 wherein the detector is removably mounted to the apparatus such that the detector is replaceable with a different detector.

12. The apparatus of claim 1 wherein the apparatus provides an alarm to a user when the predetermined condition has been detected.

13. The apparatus of claim 1 wherein the detection data and the location data for the different times is used to generate a report of locations where the predetermined condition was detected.

14. A system comprising:
a mobile apparatus comprising:
a transporter configured to transport the apparatus based on received instructions;
a detector configured to detect a predetermined condition;
a receiver configured to receive data from GPS receivers, which include one or more differential GPS receivers; and
a memory configured to store, for each of different times:
detection data from the detector indicative of whether the predetermined condition was detected; and
location data from the receiver related to the data received from the GPS receivers; and
a processor configured to determine, for each of the different times:
whether the predetermined condition was detected based on the detection data; and
a location of the apparatus based on the location data.

15. A method comprising:
transporting an apparatus based on received digital instructions, the apparatus comprising:
a detector configured to detect a predetermined condition;
a receiver configured to receive data from GPS receivers, which include one or more differential GPS receivers; and
a memory;
storing in the memory, for each of different times:
detection data from the detector indicative of whether the predetermined condition was detected; and
location data from the receiver related to the data received from the GPS receivers; and
determining, by a processor, for each of the different times:
whether the predetermined condition was detected based on the detection data; and
a location of the apparatus based on the location data.
